(19) United States
(12) Patent Application Publication
(10) Pub. No.: US 2026/0065004 A1
(43) Pub. Date: Mar. 5, 2026

(54) PRINTING METHOD, CONTROL METHOD OF PRINTING APPARATUS, AND PRINTING APPARATUS

(71) Applicant: SEMES CO., LTD., Cheonan-si (KR)

(72) Inventor: Jun Ho KIM, Pyeongtaek-si (KR)

(73) Assignee: SEMES CO., LTD., Cheonan-si (KR)

(21) Appl. No.: 19/307,178

(22) Filed: Aug. 22, 2025

(30) Foreign Application Priority Data
Sep. 3, 2024 (KR) 10-2024-0119206

(51) Int. Cl. G06K 15/02; G06K 15/10

(52) U.S. Cl. CPC G06K 15/1857; G06K 15/027; G06K 15/102; G06K 15/1851

(57) ABSTRACT

Provided is a printing method including: performing a plurality of processing cycles, in which a print image is printed on a substrate in each of the processing cycles, in which the print image used in each of the processing cycles is formed of a plurality of divided images, the plurality of divided images includes a first divided image printed at a first position of the substrate and a second divided image printed at a second position of the substrate, and the first divided image and the second divided image are generated in different processing cycles.

### CROSS-REFERENCE TO RELATED APPLICATIONS

This application claims priority to and the benefit of Korean Patent Application No. 10-2024-0119206 filed in the Korean Intellectual Property Office on Sep. 3, 2024, the entire contents of which are incorporated herein by reference.

### TECHNICAL FIELD

The present invention relates to a printing method, a control method of a printing apparatus, and a printing apparatus, and more specifically, to a printing method, a control method of a printing apparatus, and a printing apparatus for manufacturing a display panel by discharging ink onto a substrate.

### BACKGROUND ART

Manufacturing a display panel goes through several processes. In general, the manufacturing of the display panel includes a process of forming various functional layers on a glass substrate and implementing desired electrical and optical properties through the functional layers. Various techniques, such as thin film deposition, photolithography, etching, laser process, and inkjet printing, are used in this process. Each process has an important influence on the quality and performance of the display panel, and the precision of each process is very important, especially in the manufacturing of high-resolution and large-area displays.

In order to manufacture a display panel, it is essential to apply ink accurately to a specific location. To this end, a technology for discharging ink in the form of droplets to an accurate position on a glass substrate is required, and inkjet devices are widely used in this process. The inkjet device converts ink into fine droplets and precisely sprays the converted ink to a designated position on a glass substrate.

However, when the inkjet device performs printing on a glass substrate, a corresponding operation is performed using a print image. The print image includes information on the impact position of the ink droplets discharged on the glass substrate, the volume of the ink droplets, the type of ink, and a nozzle participating in printing.

In general, inkjet devices perform tests on nozzles before starting printing. Then, a print image is generated by reflecting the state of the nozzle, and printing is performed using the generated print image. However, since printing does not proceed before the print image is generated in this process, a problem of increasing the overall process time may occur. This may be a factor that lowers production efficiency, especially in situations where mass production is required.

In recent years, as the substrate of the display panel becomes large and the demand for process precision increases, the time required to generate a print image is also greatly increased. Accordingly, there is a problem that the overall process time is further increased due to a delay occurring in the process of generating a print image, which is an important cause that hinders productivity.

### SUMMARY OF THE INVENTION

The present invention has been made in an effort to provide a printing method, a control method of a printing apparatus, and a printing apparatus capable of efficiently performing printing on a substrate.

The present invention has also been made in an effort to provide a printing method, a control method of a printing apparatus, and a printing apparatus capable of reducing the number of sheets of substrates that are processible per unit time while minimizing the decrease in printing quality for substrates.

The present invention has also been made in an effort to provide a printing method, a control method of a printing apparatus, and a printing apparatus capable of minimizing the decrease in the number of sheets of substrates that are processible per unit time even when the time required to generate a print image increases.

The objectives of the present disclosure are not limited thereto and other objectives not stated herein may be clearly understood by those skilled in the art from the following description.

An exemplary embodiment of the present invention, a printing method, comprising: performing a plurality of processing cycles, in which a print image is printed on a substrate in each of the processing cycles, wherein the print image used in each of the processing cycles is formed of a plurality of divided images, the plurality of divided images includes a first divided image printed at a first position of the substrate and a second divided image printed at a second position of the substrate, and the first divided image and the second divided image may be generated in different processing cycles.

According to the exemplary embodiment of the present invention, wherein one of the first divided image and the second divided image used in the N^{th} processing cycle is generated in the N−1^{st} cycle, and the N may be a natural number greater than or equal to 2.

According to the exemplary embodiment of the present invention, wherein the other one of the first divided image and the second divided image used in the N^{th} processing cycle is generated in the N−2^{nd} cycle, and the N may be a natural number greater than or equal to 3.

According to the exemplary embodiment of the present invention, wherein the other one of the first divided image and the second divided image used in the N^{th} processing cycle may be generated in the N^{th} cycle.

According to the exemplary embodiment of the present invention, wherein while printing any one of the first divided image and the second divided image is performed, the other one of the first divided image and the second divided image may be generated.

According to the exemplary embodiment of the present invention, wherein the print image used in the N^{th} processing cycle further includes a third divided image printed at a third position different from the first position and the second position of the substrate, any one of the first divided image, the second divided image, and the third divided image used in the N^{th} processing cycle is generated in the N−3^{rd} cycle, another one of the first divided image, the second divided image, and the third divided image used in the N^{th} processing cycle is generated in the N−2^{nd} processing cycle, and the remaining one of the first divided image, the second divided image, and the third divided image used in the N^{th} processing cycle is generated in the N−1^{st} cycle, and the N may be a natural number greater than or equal to 4.

According to the exemplary embodiment of the present invention, wherein each of the processing cycles may include, a test operation of testing a head unit having a plurality of nozzles that discharges ink to check states of the nozzles; a print image generation operation of, based on the states of the nozzles checked in the test operation, generating at least one of the divided images containing information about the nozzles to participate in printing; and a print operation of performing printing on the substrate by using the print image.

According to the exemplary embodiment of the present invention, wherein in each of the processing cycles, the print image generation operation and the print operation may be performed after the test operation.

According to the exemplary embodiment of the present invention, wherein in each of the processing cycles, the print image generation operation and the print operation may be performed in parallel.

An exemplary embodiment of the present invention, a control method of controlling a printing apparatus, the printing apparatus including: a printing stage; a transfer unit for transferring a substrate on the printing stage; and a head unit for discharging ink to the substrate transferred by the transfer unit, the control method comprising: performing printing on the substrate by using a print image in which divided images generated at different times may be combined.

According to the exemplary embodiment of the present invention, wherein some of the divided images are generated in a preparation cycle, which is a cycle before the printing may be performed.

According to the exemplary embodiment of the present invention, wherein the preparation cycle may include a test operation of testing the head unit and a print image generation operation of generating an entirety of the print image.

According to the exemplary embodiment of the present invention, wherein each processing cycle of performing printing on a substrate is performed multiple times, and in each processing cycle, the print image is printed on the substrate, a portion of the divided images used in the N^{th} processing cycle is generated in the N−2^{nd} processing cycle, and the other portion of the divided images used in the N^{th} processing cycle is generated in the N−1^{st} processing cycle, where N may be a natural number greater than or equal to 3.

According to the exemplary embodiment of the present invention, wherein each processing cycle of performing printing on a substrate is performed multiple times, and in each processing cycle, the print image is printed on the substrate, in the processing cycle of an even-numbered cycle, a first divided image among the divided images is generated, and in the processing cycle of an odd-numbered cycle, a second divided image among the divided images may be generated.

According to the exemplary embodiment of the present invention, wherein a portion of the divided images is generated in the processing cycle in which the printing may be performed.

According to the exemplary embodiment of the present invention, wherein each of the processing cycles may include, a test operation of testing nozzles of the head unit to check states of the nozzles; a print image generation operation of, based on the states of the nozzles checked in the test operation, generating at least one of the divided images containing information about the nozzles to participate in printing; and a print operation of performing printing on the substrate by using the print image.

An exemplary embodiment of the present invention, a printing apparatus, comprising: a printing stage; a transfer unit for transferring a substrate on the printing stage; and a maintenance stage arranged in parallel with the printing stage; a gantry configured to extend along a direction in which the printing stage and the maintenance stage are placed; a head unit travelling along a direction in which the gantry extends, and having a plurality of nozzles that discharges ink to the substrate transferred by the transfer unit; and a controller, wherein the controller prints a print image on the substrate by discharging ink through the nozzle of the head unit, in which the print image is formed of a plurality of divided images, each of which contains information about nozzles participating in printing, and a first divided image among the divided images is generated at a first time, and a second divided image among the divided images may be generated at a second time different from the first time.

According to the exemplary embodiment of the present invention, the apparatus may further include a test unit disposed on the maintenance stage and allowing the nozzles of the head unit to perform test discharge, wherein the controller evaluates states of the nozzles based on a result of the discharge performed by the head unit to the test unit, and may selects nozzles to participate in the printing of the divided images based on a result of the evaluation of the states of the nozzles.

According to the exemplary embodiment of the present invention, wherein the controller generates the first divided image and the second divided image within two cycles prior to the cycle in which the print image may be printed.

According to the exemplary embodiment of the present invention, wherein the two cycles prior to the cycle include a preparation cycle that is performed before the print image may be printed.

According to the exemplary embodiment of the present invention, it is possible to efficiently perform printing on a substrate.

In addition, according to the exemplary embodiment of the present invention, it is possible to minimize the decrease in the number of sheets of substrates that are processible per unit time while minimizing the decrease in printing quality for substrates.

In addition, according to the exemplary embodiment of the present invention, it is possible to minimize the decrease in the number of sheets of substrates that are processible per unit time even when the time required to generate a print image increases.

Effects of the present disclosure are not limited to those described above and effects not stated above will be clearly understood to those skilled in the art from the specification and the accompanying drawings.

### BRIEF DESCRIPTION OF THE DRAWINGS

FIG. 1 is a diagram illustrating a printing apparatus according to an exemplary embodiment of the present invention.

FIG. 2 is a diagram of a nozzle plate of a head of FIG. 1 viewed from below.

FIG. 3 is a flowchart illustrating a printing method according to an exemplary embodiment of the present invention.

FIG. 4 is a diagram illustrating an appearance of a printing apparatus performing a test operation of FIG. 3.

FIGS. 5 and 6 are diagrams illustrating an appearance of the printing apparatus performing a print operation of FIG. 3.

FIG. 7 is a flowchart illustrating an existing N+0 type printing method.

FIG. 8 is a flowchart illustrating an existing N+1 type printing method.

FIG. 9 is a flowchart illustrating an N+½ type printing method according to an exemplary embodiment of the present invention.

FIG. 10 is a graph illustrating the number of defects occurring in a substrate according to a printing manner.

FIG. 11 is a flowchart illustrating an existing N+⅓ type printing method.

FIG. 12 is a flowchart illustrating an N+½ type printing method according to another exemplary embodiment of the present invention.

The various features and advantages of the non-limiting exemplary embodiment of the present specification may become more apparent by reviewing the detailed description together with the accompanying drawings. The accompanying drawings are provided for illustrative purposes only and should not be construed as limiting the scope of claims. The accompanying drawings are not considered to be drawn to scale unless explicitly stated. For clarity, the various dimensions of the drawings may have been exaggerated.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

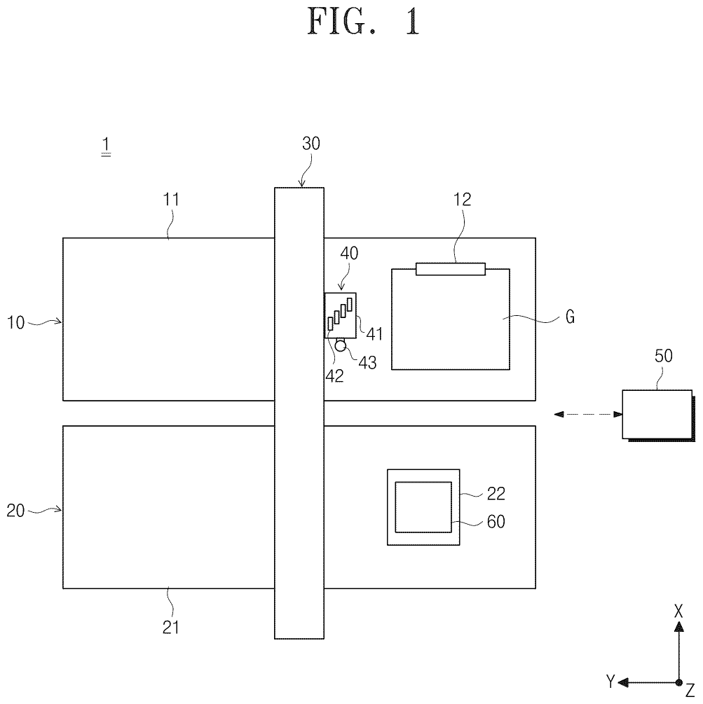

Hereinafter, an exemplary embodiment of the present invention will be described with reference to FIGS. 1 to 12.

FIG. 1 is a diagram illustrating a printing apparatus according to an exemplary embodiment of the present invention.

Referring to FIG. 1, a printing apparatus 1 according to an exemplary embodiment of the present invention may discharge ink to a substrate G. The printing apparatus 1 may perform a film forming process of forming a film by discharging ink to the substrate G. The printing apparatus 1 may perform printing by discharging ink to the substrate G. The printing apparatus 1 may be an inkjet apparatus. The substrate G may be a glass substrate. A print image IN which will be described later (N is an integer equal to or larger than 0) may be printed on the substrate G. The printing apparatus 1 may discharge ink to the substrate G to manufacture a quantum dot color filter.

The printing apparatus 1 may include a printing unit 10, a maintenance unit 20, a gantry 30, a head unit 40, a controller 50, and a test unit 60.

The printing unit 10 may be a region in which printing on the substrate G is performed. The printing unit 10 may include a printing stage 11 and a transfer gripper 12 (an example of a transfer unit). The substrate G may be loaded on and/or unloaded from the printing stage 11. The printing stage 11 may float the substrate G by injecting air into a lower surface of the substrate G. When the lower surface of the substrate G directly contacts the stage 11, impurities, such as particles, may occur due to contact. Such impurities may be attached to an upper surface of the substrate G, thereby deteriorating the quality of the manufactured display panel. To solve this problem, the printing stage 11 injects air into the lower surface of the substrate G and separates the lower surface of the substrate G from the printing stage 11.

The floating substrate G may be gripped by the transfer gripper 12. The transfer gripper 12 may grip one side (opposite sides if necessary) of the substrate G. The transfer gripper 12 may grip the lower portion of the edge region of the substrate G in a vacuum adsorption method. The transfer gripper 12 may be configured to move along a second direction Y. The transfer gripper 12 may grip one side of the floating substrate G and may move the substrate G along the second direction Y while moving along the second direction Y.

Hereinafter, a direction in which the substrate G is transferred by the transfer gripper 12 may be defined as the second direction Y, when viewed from above, a direction perpendicular to the second direction Y may be defined as a first direction X, and a direction perpendicular to the first direction X and the second direction Y may be defined as a third direction Z. The third direction Z may mean a direction perpendicular to the ground.

The maintenance unit 20 may be disposed in parallel with respect to the printing unit 10 in the first direction X. The maintenance unit 20 may perform maintenance, such as inspection, test discharge, purge discharge, cleaning, replacement, and repair, on the head unit 40 to be described later. The maintenance unit 20 may have a structure and environment similar to that of the printing unit 10 as a whole. For example, the printing unit 10 and the maintenance unit 20 may be disposed of in the same enclosure. Inert gas, such as nitrogen, may be supplied inside the enclosure. That is, both the printing unit 10 and the maintenance unit 20 may be controlled with an inert gas atmosphere. In this way, the printing unit 10 and the maintenance unit 20 are controlled by the same or similar process environment because the maintenance unit 20 may perform a test discharge or the like for measuring the performance of the head unit 40.

The maintenance unit 20 may include a maintenance stage 21 having the same or similar shape and function as the printing stage 11 described above, and a transfer plate 22 configured to be movable on the maintenance stage 21. The maintenance stage 21 may be disposed in parallel with the printing stage 11.

The transfer plate 22 may be configured to be movable in the second direction Y and/or the first direction X in the maintenance stage 21. The transfer plate 22 may have a seating surface on which the test unit 60 may be seated. The transfer plate 22 may be moved in the first direction X and/or the second direction Y by an actuator, such as a motor, which is not illustrated. When the head unit 40 is positioned above the maintenance unit 20 for test discharge, the transfer plate 22 may position the test unit 60 below the head unit 40.

The gantry 30 may have vertical extension portions extending vertically and horizontal extension portions extending horizontally. The vertical extension portions may be located at the sides of the printing stage 11 of the printing unit 10 and the maintenance stage 21 of the maintenance unit 20, respectively. And the horizontal extension portion may be disposed above the printing stage 11 and the maintenance unit 20. The horizontal extension portion may extend along the first direction X in which the printing stage 11 and the maintenance stage 21 are disposed.

In addition, the gantry 30 may be provided with a moving mechanism capable of moving the head unit 40. For example, the moving mechanism of the gantry 30 may include a motor, a guide rail, a moving bracket moving along the guide rail, and the like. The head unit 40 may be moved along the first direction X by the moving mechanism. The head unit 40 may move between the printing unit 10 and the maintenance unit 20 by the gantry 30. When the head unit 40 is located above the printing unit 10, a printing process may be performed on the substrate G. Even when the head unit 40 is located above the maintenance unit 20, maintenance, such as inspection, test discharge, purge discharge, cleaning, replacement, and repair, of the head unit 40 may be performed.

The head unit 40 may discharge ink to the substrate G. The head unit 40 may discharge ink to the substrate G in the form of droplets. Ink discharged in the form of droplets may be referred to as ink droplets. The head unit 40 may discharge RGB ink, such as red ink, green ink, and blue ink, on the substrate G, and alternatively, may discharge ink for forming a protective film on the substrate G.

The head unit 40 may include a housing 41, a plurality of heads 42, and a vision 43.

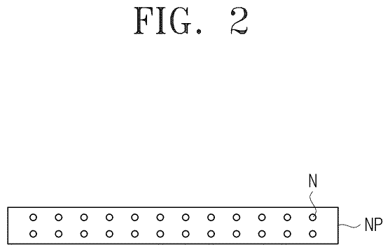

The housing 41 may be coupled to the movement mechanism of the gantry 30. The housing 41 may be a body part into which the head 42 is inserted and fixed. The plurality of heads 42 may be inserted into and fixed to the housing 41. Each of a plurality of heads 42 may have a nozzle plate NP as illustrated in FIG. 2. The plurality of nozzles N may be formed on each nozzle plate NP. Each nozzle N may discharge ink in the form of droplets. Each head 42 may be provided with a droplet discharge means, such as a piezo element, so as to adjust the volume of the unit ink in the form of droplets. The volume of the unit ink discharged to the substrate G may be adjusted by the intensity of the current applied to the piezo element, the time during which the current is applied to the piezo element, and the like.

Although FIG. 2 illustrates that the number of nozzles N formed in the nozzle plate NP is 24, the present invention is not limited thereto. For example, the number of nozzles N formed on each nozzle plate NP may be variously modified in several tens to several thousands of numbers.

Referring back to FIG. 1, the vision 43 may be installed on the side of the housing 41. The vision 43 may be a camera including a lighting. The vision 43 may collect an image of ink discharged to the substrate G. The ink discharged to the substrate G may mean an ink in the form of droplets impacted on the surface of the substrate G or falling to be impacted on the surface of the substrate G. The vision 43 may collect an image that may check the discharge position of the ink in the form of droplets on the substrate G, the volume of the discharged ink, and the like. In addition, the vision 43 may collect an image of ink discharged to the test unit 60 to be described later. Accordingly, the controller 50 to be described later may check whether any one of the nozzles N of the head unit 40 corresponds to a defective nozzle.

The controller 50 controls the operation of the printing apparatus 1. The controller 50 may generate a control signal for controlling the operation of the printing apparatus 1. The controller 50 may include a process controller formed of a microprocessor (computer) that executes the control of the printing apparatus 1, a user interface formed of a keyboard in which an operator performs a command input operation or the like in order to manage the printing apparatus 1, a display for visualizing and displaying an operation situation of the printing apparatus 1, and the like, and a storage unit storing a control program for executing the process executed in the printing apparatus 1 under the control of the process controller or a program, that is, a treating recipe, for executing the process in each component according to various data and treating conditions. In addition, the controller 50 may include a storage medium for storing a program for the printing apparatus 1 to implement a printing method described later. The storage medium may be provided as a portable disk, such as a hard disk, a CD-ROM, or a DVD, or a semiconductor memory, such as a flash memory.

The test unit 60 may be provided to the maintenance unit 20. The test unit 60 may be disposed on the maintenance stage 21. The test unit 60 may provide a test member. The test member may be a test film or a test substrate on which the head unit 40 may perform test discharge. For example, the test unit 60 may be provided in a structure capable of withdrawing and recovering a test film in a roll-to-roll method. When the head unit 40 is located above the test unit 60, the head unit 40 discharges ink in the form of droplets to the test member provided by the test unit 60. In addition, the state of the nozzles N of the head unit 40 may be evaluated through the result of the discharge occurring to the test member, such as the presence or absence of the impact of the ink, the location of the impact, and the volume of the ink impacted.

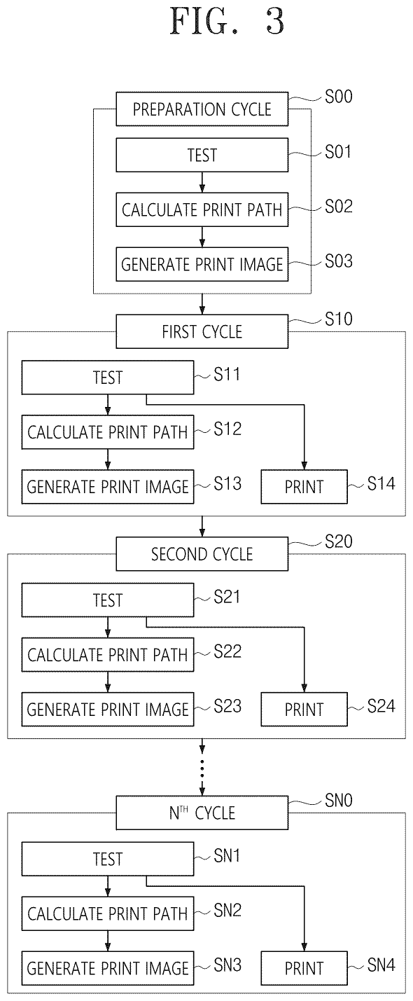

FIG. 3 is a flowchart illustrating a printing method according to an exemplary embodiment of the present invention. The printing method described below may be implemented by the printing apparatus 1. Furthermore, the printing method described below may be implemented by a control method for controlling the printing apparatus 1. Furthermore, in order to implement the printing method described below, the controller 50 may control the components of the printing apparatus 1.

For example, the controller 50 may control the components of the printing unit 10, the maintenance unit 20, the gantry 30, and the head unit 40 of the printing apparatus 1. Additionally, to implement the printing method described below, the controller 50 may receive and analyze images of the ink-discharged test member from the vision 43 or the like to determine the result of the test discharge discharged to the test unit 60.

Referring to FIG. 3, a printing method according to an exemplary embodiment of this invention may include a preparation cycle S00 and a plurality of processing cycles SN0 (N is a natural number greater than or equal to 1). The preparation cycle S00 and the plurality of processing cycles SN0 may be sequentially performed.

The preparation cycle S00 may be a cycle before the first processing cycle S10 is performed. The preparation cycle S00 may be a cycle after the printing apparatus 1 is set up and before the first processing cycle S10 is performed. Alternatively, the preparation cycle S00 may be a cycle after the printing apparatus 1 is maintained and before the first processing cycle S10 is performed.

Alternatively, the user may temporarily stop the operation of the printing apparatus 1 in order to process the substrate G by a preset number of sheets to be processed and then provide a pause period to the printing apparatus 1. The preparation cycle S00 may mean a cycle after the pause period of the printing apparatus 1 and before the first processing cycle S00 is performed again.

In addition, the preparation cycle S00 may mean a cycle before the first processing cycle S10, which is the first processing cycle, is performed after the process recipe for the substrate G is changed, such as a change in the type of substrate G on which the printing apparatus 1 is to perform printing, a change in the print image to be printed on the substrate G, a change in the type of ink discharged to the substrate G, or a change in the type of process performed on the substrate G.

The processing cycle SN0 may include performing printing on the substrate G. In each processing cycle SN0, printing on one sheet of the substrate G may be completed. For example, printing may be performed on the first substrate G in the first processing cycle S10, printing may be performed on the second substrate G in the second processing cycle S20, and printing may be performed on the N^{th} substrate G in the N^{th} processing cycle SN0. The first substrate G, the second substrate G, and the N^{th} substrate G may all refer to different substrates G.

Since each processing cycle SN0 includes a printing operation SN4 (N is a natural number greater than or equal to 1), while the preparation cycle S00 is the cycle before the processing cycle SN0 is performed, there may be a difference in that the preparation cycle S00 does not include the printing operation SN4 for the substrate G.

Each of the preparation cycle S00 and the plurality of processing cycles SN0 may include a test operation SN1 (N is an integer greater than or equal to 0), a print path calculation operation SN2 (N is an integer greater than or equal to 0), and a print image generation operation SN3 (N is an integer greater than or equal to 0).

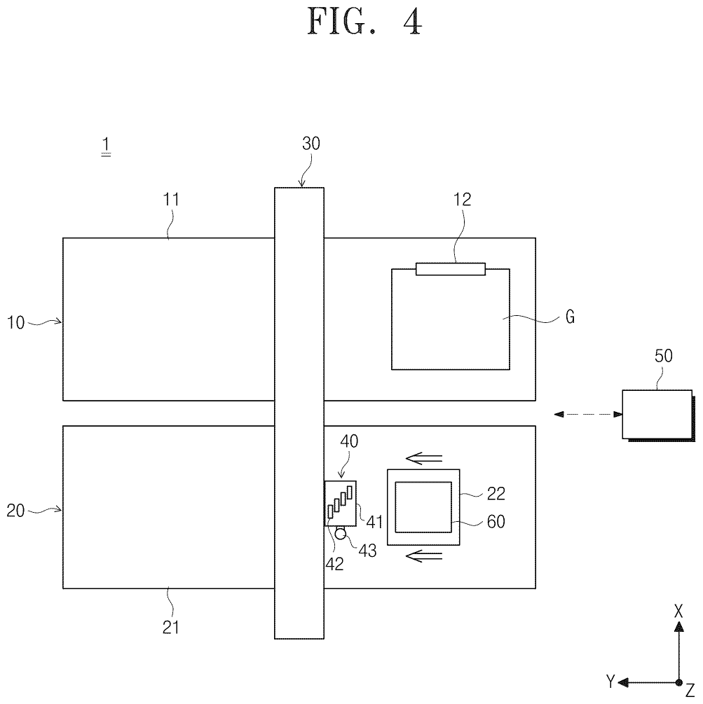

FIG. 4 is a diagram illustrating an appearance of a printing apparatus performing a test operation of FIG. 3.

Referring to FIGS. 3 and 4, in the test operation SN1, the head unit 40 may be moved in the first direction X by the movement mechanism provided in the gantry 30 and may be positioned above the maintenance unit 20. Thereafter, the transfer plate 22 may move the test unit 60 downward from the head unit 40. In this operation, the head unit 40 may discharge the test ink to the test unit 60 in the form of droplets. The test unit 60 provides a test member, which may be formed of a test film supplied and recovered in a roll-to-roll form. Ink may be impacted on the test member.

While the test is in progress, the vision 43 may acquire an image by photographing the ink impacted on the test member. This image may be transmitted to the controller 50. The controller 50 may analyze the image transmitted by the vision 43 to evaluate the states of the nozzles N included in the head unit 40. The states of the nozzles N may be graded according to a specific criterion and managed by the controller 50.

For example, among the nozzles N, the nozzle N which is excellent in all indicators, such as the presence or absence of ink impact, the impact location, and the volume of the impacted ink, may be managed as A grade. The nozzle N which is excellent in two indicators may be managed as a B grade, the nozzle N which is excellent in one indicator may be managed as a C grade, and the nozzle N which is poor in all indicators may be managed as a D grade. This grading may be an important factor for systematically monitoring the state of the nozzles N and maintaining optimal printing quality in subsequent printing processes. However, this grade classification is an example, and the grade classification criteria may be varied in various ways.

Referring back to FIG. 3, the print path calculation operation SN2 may be performed after the test operation SN1 ends. In the print path calculation operation SN2, when the head unit 40 performs printing on the substrate G, the position of the print path, the number of print paths, the application order of the print paths, and the like capable of satisfying the requirements set by the user may be calculated.

A length of the head unit 40 in the first direction X is smaller than a length of the substrate G in the first direction X. Therefore, in order to complete printing on one substrate G through the head unit 40, printing is required multiple times. When each print is performed, the position of the head unit 40 is changed. Depending on the position of the head unit 40, the print path in which printing is performed on the substrate G varies. That is, in order to complete printing on one substrate G, printing is performed multiple times by applying different print paths. In the print path calculation operation SN2, the number of print paths, the location of the print path, the application order of the print path, and the like required to complete printing on the substrate G are calculated.

Meanwhile, the position of the print path may correspond to the printing position of the head unit 40. The position of the print path may be determined according to a change in the unit position of the head unit 40 preset by the user. For example, when the user moves the position of the head unit 40 by the set unit distance, the value calculated by dividing the length of the substrate G in the first direction X by the set unit distance may be the maximum number of print paths that may be used, and the positions of the respective print paths separated by the set unit distance may be the positions of the print paths that may be applied in the print operation SN4.

In general, the order of application of the print paths may be sequentially applied from one side of the substrate G to the other side. The order of application of the print paths may be sequentially applied from one edge of the substrate G to the other edge along the first direction X. However, the present invention is not limited thereto. For example, considering that opposite edges of the substrate G have relatively low opportunities for the head unit 40 to contribute to printing, and that the central portion of the substrate G has relatively many opportunities for the head unit 40 to contribute to printing, the order of application of the print path may be determined in the order in which the print path is applied from opposite edge portions of the substrate G, and then the print path is applied to the central portion of the substrate G.

The print path calculation operation SN2 may be implemented by a program stored in a recording medium of the controller 50. This program is an important software element designed to optimize the print path to be applied in the print operation SN4, and may include an algorithm capable of calculating the number of print paths, the location of the print path, the order of application of the print paths, and the like. This program may be implemented by computer software, and the print path may be calculated in consideration of various variables and conditions.

If necessary, the user sets in the controller 50 the number of print paths required to perform printing on the substrate G, the location of the print path, and the order of application of the print paths, and the print path calculation operation SN3 may be omitted.

In the print image generation operation SN3, a print image to be used in the print operation SN4 may be generated. The printing apparatus 1 may print a print image on the substrate G.

As described above, printing on one substrate G may be performed a plurality of times. A piece region of the substrate G on which the printing is performed by each print path may be referred to as a swath, and print images corresponding to each swath may be generated in the print image generation operation SN3.

In the print operation SN4 to be described later, a print image may be printed on the substrate G, and such the print image may be formed of a plurality of divided images. Each of the plurality of divided images may correspond to the one swap and the one print path described above. At least one or more of the plurality of divided images may be generated in print image generation operation SN3 of each cycle.

The print image generation operation SN3 may be implemented by a program stored in the controller 50, and the process of generating the print image may be referred to as rendering. The divided images generated in the print image generation operation SN3 may include information on a location where ink is discharged, the amount of ink discharged, a type of ink discharged, and the nozzle N participating in printing the corresponding print image. In this case, the information on the nozzle N participating in printing may be generated based on state information of the nozzles N checked (evaluated) in the above-described test operation SN1.

For example, in the test operation SN1, the nozzles N are graded and managed in A, B, C, and D grades according to criteria, such as the presence or absence of ink impact, the location of impact, and the volume of impacted ink, and among many nozzles N that may be used to print the divided image at each printing location, the higher-grade nozzles N may be selected first and participate in printing.

In some cases, only A-grade nozzles N may be used in parts where printing quality is very important, and B-grade or C-grade nozzles N may be used in parts where quality requirements are somewhat low.

The divided images generated in the print image generation operation SN3 include recent state information about the nozzle N. More specifically, the state information about the nozzle N tested in the test operation SN1 may be reflected in the divided images generated in the print image generation operation SN3. For example, the divided image generated in the print image generation operation S13 of the first cycle may reflect state information of the nozzle N tested in the test operation S11 of the first cycle.

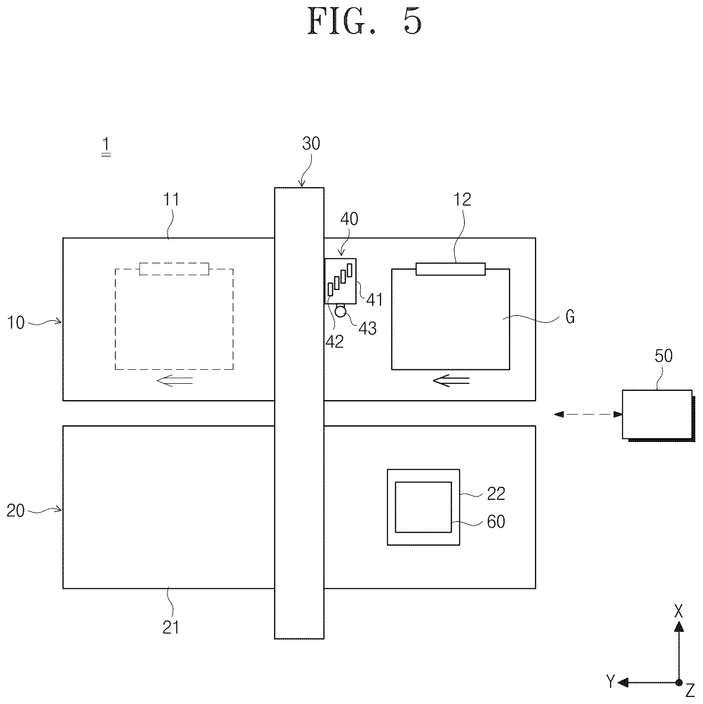

FIGS. 5 and 6 are diagrams illustrating an appearance of the printing apparatus performing the print operation of FIG. 3.

Referring to FIGS. 5 and 6, in the print operation SN4 of the present invention, the printing may be performed on the substrate G through at least one print path. For example, in the print operation S3, the printing may be performed through a plurality of print paths. FIG. 5 illustrates the printing apparatus 1 performing printing on the substrate G through the first print path, and FIG. 6 illustrates the printing apparatus 1 performing printing on the substrate G through the second print path. Printing may be implemented through the print images generated in the print image generation operation SN3 described above. When printing is performed for each print path, each corresponding divided image may be used.

The print operation SN4 may be performed in the printing unit 10, and during the print operation SN4, the head unit 40 may be located above the printing unit 10.

In the print operation SN4, when the head unit 40 performs printing through the first print path, the head unit 40 may be positioned at a first printing position. In this case, the substrate G may pass through the region under the head unit 40 located at the first printing position, and the substrate G may be transferred by the transfer gripper 12. When the substrate G passes through the region under the head unit 40, the nozzles N provided in the head unit 40 discharge ink onto the substrate G. When the head unit 40 performs printing through the second print path, the head unit 40 may be positioned at a second printing position. The second printing position may be a position different from the first printing position, and at this position, the substrate G may also pass through the region under the head unit 40 At this time, the substrate G is also transferred by the transfer gripper 12, and when the substrate G passes through the region under the head unit 40, the nozzles N of the head unit 40 discharge ink.

In addition, the transfer direction of the substrate G when the printing is performed through the first print path and the transfer direction of the substrate G when the printing is performed through the second print path may be opposite to each other. For example, when the transfer direction of the substrate G is moved forward along the second direction Y when the printing is performed through the first print path, the transfer direction of the substrate G may be moved backward along the second direction Y when the printing is performed through the second print path. This method is to accurately form a desired pattern on the substrate G through various print paths, and may contribute to increasing the flexibility and precision of the printing process.

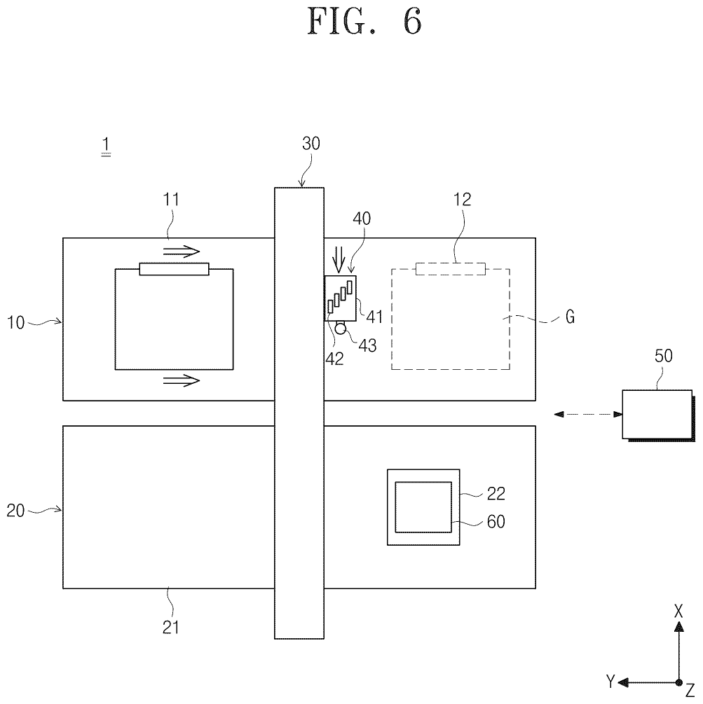

FIG. 7 is a flowchart illustrating an existing N+0 type printing method.

Referring to FIG. 7, in the N+0 type printing method, a test of the head unit 40 is performed and a print image IM of the entire region of the substrate is generated through rendering based on the state of the nozzle N derived through the test. In this case, the print image IM is formed of a plurality of divided images. Then, the print image IM generated in the corresponding processing cycle is printed on the substrate G.

In the N+0 type printing method, based on the test result of the head unit 40, a print image IM for the entire region of the substrate G is generated, and the generated print image IM is directly printed on the substrate G. That is, the N+0 type printing method is most advantageous in securing a high level of printing quality in that the most up-to-date state information of the nozzle N may be reflected in the print image IM. However, since printing on the substrate G cannot be performed until the rendering of the print image IM is completed after the test on the head unit 40 is completed, it is very disadvantageous in the number of sheets of the substrates that can be processed per unit time.

In order to solve the above problem, the N+1 type printing method may be considered.

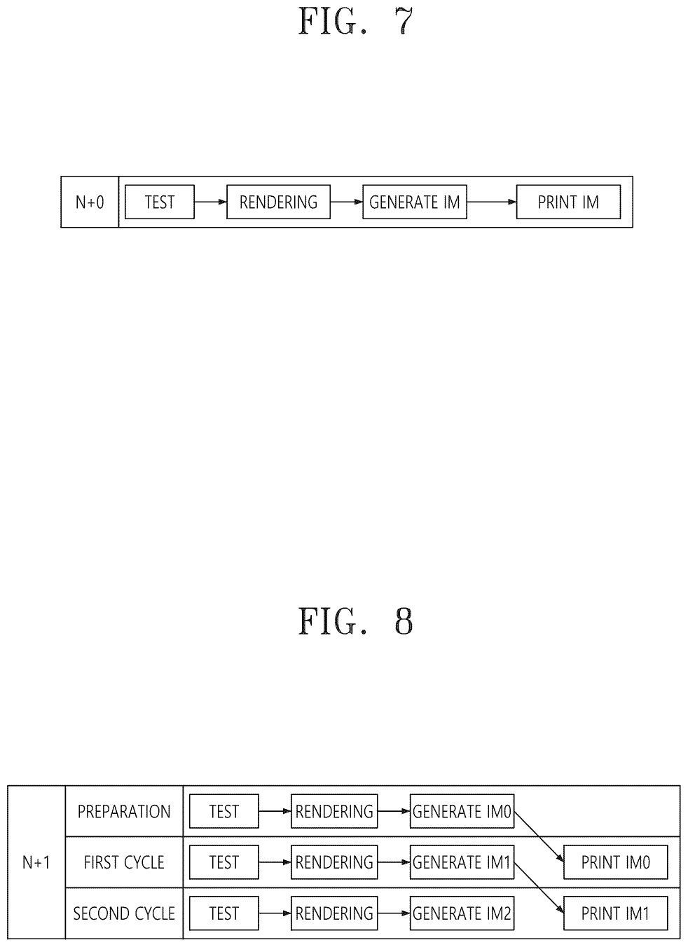

FIG. 8 is a flowchart illustrating an existing N+1 type printing method.

Referring to FIG. 8, in the N+0 type printing method, a print image IMN (N is an integer equal to or greater than 0) of the entire region of the substrate G is generated through rendering based on the state of the nozzle N derived through the corresponding test. In this case, the print image IMN is formed of a plurality of divided images, and a print image IMN used for printing in the next processing cycle is generated. Then, the generated print image IMN is printed on the substrate G in the next processing cycle. While the print image IMN is generated, printing on the substrate G is performed.

For example, in the preparation operation, the head unit 40 is tested and the print image IM0 is rendered by reflecting the state of the nozzle N through the test. Accordingly, the print image IM0 is generated.

Thereafter, in the first processing cycle, the head unit 40 is tested and the print image IM1 is rendered by reflecting the state of the nozzle N through the test. While the print image IM1 is rendered, the head unit 40 prints the print image IM0 generated in the preparation cycle on the substrate G.

Thereafter, in the second processing cycle, the head unit 40 is tested and a print image IM2 is rendered by reflecting the state of the nozzle N through the test. While the print image IM2 is rendered, the head unit 40 prints the print image IM1 generated in the first cycle on the substrate G.

Compared to the N+0 type printing method, the N+1 type printing method uses a print image IMN in which the state information of the nozzle N in the previous cycle has been reflected, which has some disadvantages in terms of securing print quality. However, although the print image IMN in which the state information of the nozzle N in the past cycle has been reflected is printed, since the print image IMN in which the state information of the nozzle N in the immediately previous cycle has been reflected is printed, there may be no significant deterioration in printing quality. In addition, there is an advantage in the number of sheets of the substrates that can be processed per unit time in that the rendering of the print image IMN and the printing of the print image IMN on the substrate G may be performed in parallel. That is, the N+1 type printing method has the advantage of minimizing a decrease in the number of sheets of the substrate that can be processed per unit time without significantly reducing printing quality.

However, due to the large area of the substrate G and the high resolution of the print image according to the high level of print quality requirements, the time required to generate the print image has increased significantly. In other words, as the time required to render a print image increases significantly, even if the N+1 type printing method is applied, printing on the substrate G must be stopped until the rendering is completed. For example, the printing of the second cycle needs to be performed, but the rendering of the print image that started in the first cycle may not have been completed.

The present invention provides the printing method, the control method of the printing apparatus, and the printing apparatus for solving the above-described problems that may occur when the printing method of the N+0 and N+1 types are applied.

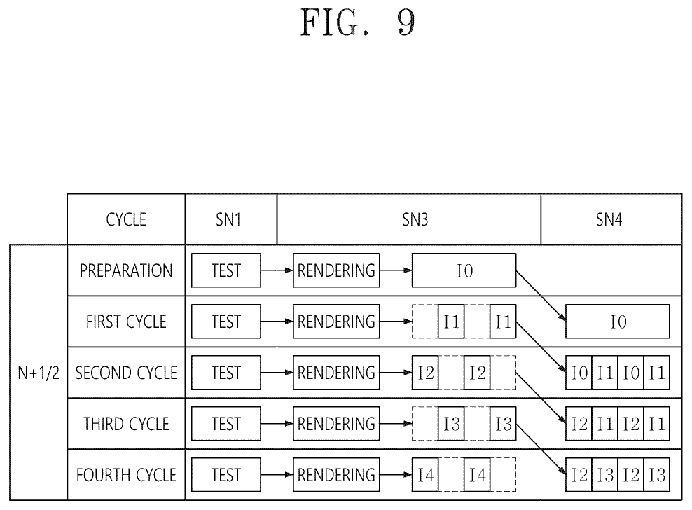

FIG. 9 is a flowchart illustrating an N+½ type printing method according to an exemplary embodiment of the present invention.

Referring to FIG. 9, in the N+½ type printing method, the region of the substrate G is divided by ½. And, in each processing cycle SN0, the print image is rendered only for the divided region. Hereinafter, a description of the print path calculation operation SN2 will be omitted.

In a preparation cycle S00, a test operation S01 and a print image generation operation S03 are performed to generate a preparatory print image I0. The preparatory print image I0 may be a print image for the entire region of the substrate G, and may be formed of a plurality of divided images.

In the first processing cycle S10, a test operation S11 and a print image generation operation S13 are performed. In the print image generation operation S13, first divided images I1, which are print images corresponding to a first region of the substrate G divided by ½, may be generated (rendered).

The first divided images I1 may be images printed at a first position (which may also be referred to as an odd position) of the substrate G. In this case, in parallel with the print image generation operation S13, the preparatory print image I0 may be printed on the substrate G in a print operation S14.

In the second processing cycle S20, a test operation S21 and a print image generation operation S23 are performed. In the print image generation operation S23, second divided images I2, which are print images corresponding to a second region, which is the other region divided as ½ of the substrate G, may be generated (rendered). The second divided images I2 may be images printed at a second position (which may also be referred to as an even position) that is different from the first position of the substrate G.

In this case, in parallel with the print image generation operation S23, in the print operation S24, a part of the preparatory print image I0 generated in the preparation operation S00 and the print image consisting of the first divided images I1 may be printed on the substrate G.

In the third processing cycle S30, a test operation S31 and a print image generation operation S33 are performed. In the print image generation operation S33, third divided images I3, which are print images corresponding to the first region, which is the other region divided as ½ of the substrate G, may be generated (rendered). The third divided images I3 may be images printed at the first position (which may also be referred to as an odd position) of the substrate G. The third divided images I3 may be the same as the first divided image I1 described above except for information about the nozzle N participating in printing. In some cases, the third divided image I3 may also be referred to as a first divided image.

In this case, in parallel with the print image generation operation S33, the print image formed of the first divided image I1 and the second divided image I2 may be printed on the substrate G in the print operation S34.

In the fourth processing cycle S40, a test operation S41 and a print image generation operation S43 are performed. In the print image generation operation S43, fourth divided images I4, which are print images corresponding to the second region, which is the other region divided as ½ of the substrate G, may be generated (rendered). The fourth divided images I4 may be images printed at the second position (which may also be referred to as an even position) of the substrate G. The fourth divided images I4 may be the same as the second divided image I2 described above except for information about the nozzle N participating in printing. In some cases, the fourth divided image I4 may also be referred to as the second divided image.

In this case, in parallel with the print image generation operation S43, the print image formed of the second divided image I2 and the third divided image I3 may be printed on the substrate G in the print operation S34.

The N+½ type printing method repeats the above-described process. When the region of the substrate G is divided by ½, divided images corresponding to the first position and the second position occur alternately in odd and even cycles, which has the technical advantage of solving the problem of stains on printed results.

In the present invention, the print image used in the print operation is formed of a plurality of divided images. Further, the plurality of divided images includes the first divided image, the second divided image, the third divided image, the fourth divided image, . . . , and each of the divided images may be generated at different times (different cycles, herein the cycle includes not only the processing cycle SN0 but also the preparation cycle S00). For example, the first divided images may be generated in the first processing cycle S10, the second divided images may be generated in the second processing cycle S20, and the third divided image may be generated in the third processing cycle S30.

In other words, at least some of the divided images included in the print image used in the N^{th} processing cycle may be generated in other cycles.

As in the exemplary embodiment of the present invention, since the region of the substrate G is divided by ½ and only divided images corresponding to ½ of the substrate G are rendered in each processing cycle SN0, the time required to generate an image may be greatly reduced. Therefore, it is possible to effectively solve the problem of not starting the print operation SN4 while rendering the image. This method may effectively cope with an increase in rendering time due to a large area of the substrate G and a high resolution of the print image.

In addition, in the N+½ type printing method of the present invention, a print image is formed by combining divided images generated in the previous cycle and the preceding cycle of the previous cycle, and printing on the substrate G is performed based on the formed print image. In this way, it was confirmed that even if the divided image generated in the preceding cycle of the previous cycle was used, the printing quality for the substrate G was not significantly lowered.

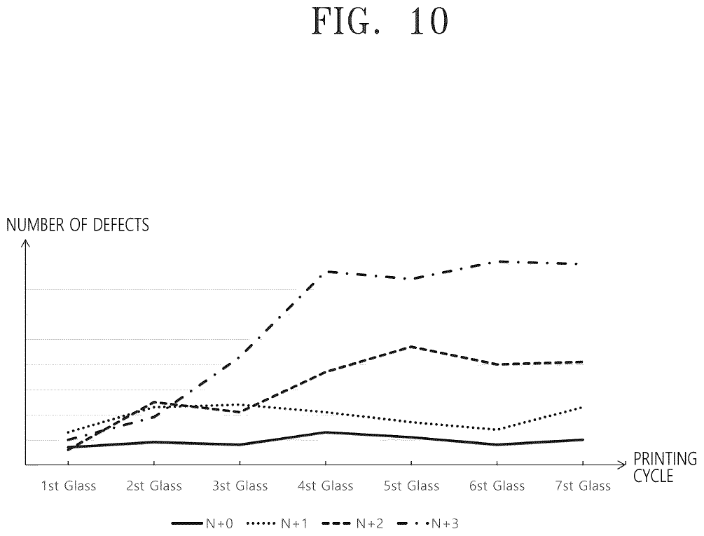

FIG. 10 is a graph illustrating the number of defects occurring in a substrate according to a printing manner.

FIG. 10 illustrates the number of defects occurring on the substrate G according to the number of sheets of the substrate G processed when a print image is generated and the generated image is printed on the substrate G. The number of defects may be variously understood, such as the number of particles, the number of spots, the number of irregularities, the number of errors at the impact position, the number of ink droplets having a size different from the set value on the substrate G and the like.

Referring to FIG. 10, when printing is performed by using the N+0 type printing method, that is, by using the print image generated in the current cycle, it shows the lowest defect level.

When printing is performed by using the N+1 type printing method, that is, by using the print image generated in the cycle before the first cycle, it shows a relatively higher defect level than the N+0 type printing method, but shows a stable defect level overall.

When printing is performed by using the N+1 type printing method, that is, by using the print image generated in the cycle before the two cycles, it shows a relatively higher defect level than the N+0 and N+1 type printing methods, but shows a stable defect level overall.

When printing is performed by using the N+3 type printing method, that is, by using the print image generated in the cycle before the three cycles, it shows a higher defect level than the N+0, N+1, and N+2 type printing methods.

In summary, considering the overall tact time and the defect pattern, a stable impact were observed up to the image generated in the previous second cycle.

Accordingly, according to the exemplary embodiment of the present invention, the first divided image used in the N^{th} processing cycle SN0 may be generated in the N−2^{nd} cycle and the second divided image may be generated in the N−1^{st} cycle. Here, N may be a natural number greater than or equal to 3.

That is, the present invention divides the region of the substrate G, and renders a print image only to each region divided in each processing cycle SN0. Accordingly, a time required to render a print image in each processing cycle SN0 may be greatly reduced. In addition, even if the controller 50 does not implement a high-speed rendering operation using a GPU or the like, a print image may be effectively generated within a certain tact time.

In addition, the present invention may minimize the deterioration of printing quality for the substrate G by using even the image generated in the previous second cycle when printing is performed on the substrate G.

Additionally, when the divided image is repeatedly used several times, the old divided image may not reflect the latest state of the nozzle N, but the present invention divides the region of the substrate G and generates divided images printed in the divided region in order, thereby solving the problem of using images corresponding to a specific region for an excessively long time.

In the above-described example, the N+½ type printing method in which the region of the substrate G is divided in ½ has been described, but the present invention is not limited thereto.

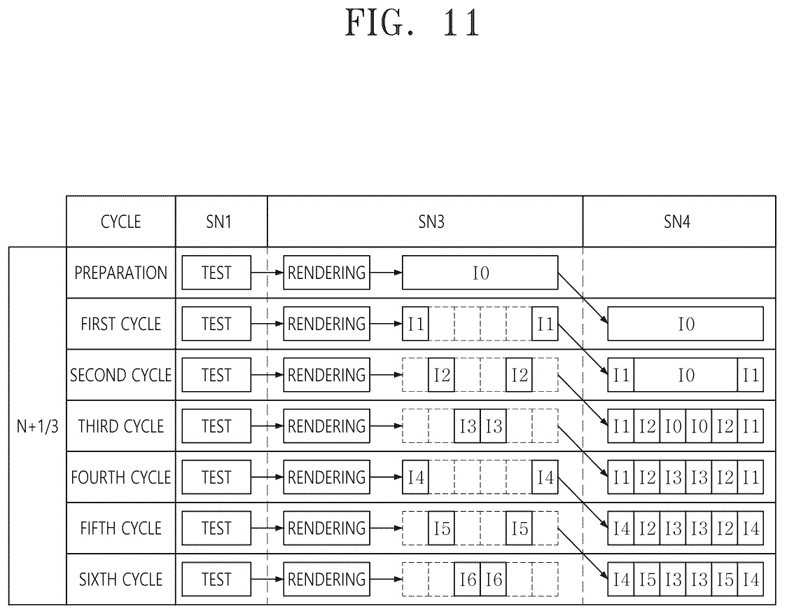

For example, an N+⅓ type printing method in which the region of the substrate G is divided by ⅓, as illustrated in FIG. 11, may also be considered.

In this case, the print image used in the N^{th} processing cycle SN0 may include a first divided image printed at a first position of the substrate G, a second divided image printed at a second position, and a third divided image printed at a third position.

The first divided image may be generated in N−3^{rd} processing cycle, the second divided image may be generated in N−2^{nd} processing cycle, and the third divided image may be generated in N−1^{st} processing cycle. Here, N may be a natural number greater than or equal to 4.

In addition, not only the case of dividing the region of the substrate G by ½, ⅓, etc., but also the case of dividing the region of the substrate G by 1/N (N is a natural number greater than or equal to 2) may be considered.

In the above-described example, the present invention has been described based on the case where the print image used in the N^{th} processing cycle SN0 is formed of only divided images generated in the cycles before the current cycle, such as the N−1^{st} cycle and the N−2^{nd} cycle, but the present invention is not limited thereto.

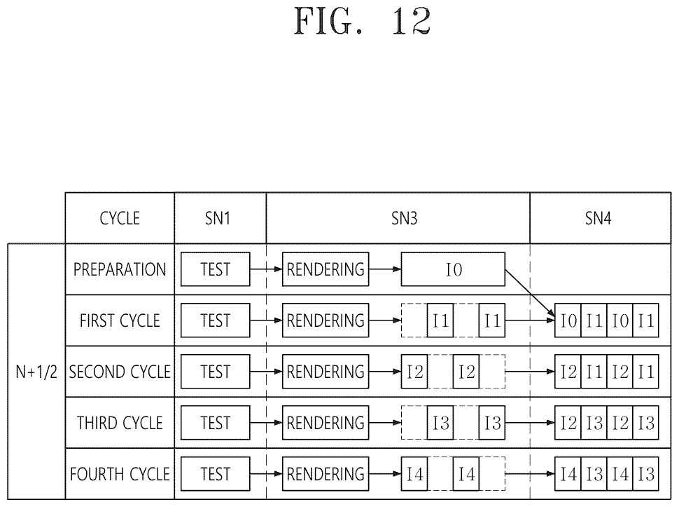

For example, as illustrated in FIG. 12, the print image used in the N^{th} processing cycle SN0 may be formed of divided images generated in the N−1^{st} cycle and the N^{th} cycle (the current cycle).

It should be understood that exemplary embodiments are disclosed herein and other modifications may be possible. Individual elements or features of a particular exemplary embodiment are not generally limited to the particular exemplary embodiment, but are interchangeable and may be used in selected exemplary embodiments, where applicable, even when not specifically illustrated or described. The modifications are not to be considered as departing from the spirit and scope of the present disclosure, and all such modifications that would be obvious to one of ordinary skill in the art are intended to be included within the scope of the accompanying claims.

1. A printing method, comprising:
performing a plurality of processing cycles, in which a print image is printed on a substrate in each of the processing cycles,
wherein the print image used in each of the processing cycles is formed of a plurality of divided images,
the plurality of divided images includes a first divided image printed at a first position of the substrate and a second divided image printed at a second position of the substrate, and
the first divided image and the second divided image are generated in different processing cycles.

2. The printing method of claim 1, wherein one of the first divided image and the second divided image used in the N^{th} processing cycle is generated in the N−1^{st} cycle, and the N is a natural number greater than or equal to 2.

3. The printing method of claim 2, wherein the other one of the first divided image and the second divided image used in the N^{th} processing cycle is generated in the N−2^{nd} cycle, and the N is a natural number greater than or equal to 3.

4. The printing method of claim 2, wherein the other one of the first divided image and the second divided image used in the N^{th} processing cycle is generated in the N^{th} cycle.

5. The printing method of claim 4, wherein while printing any one of the first divided image and the second divided image is performed, the other one of the first divided image and the second divided image is generated.

6. The printing method of claim 1, wherein the print image used in the N^{th}processing cycle further includes a third divided image printed at a third position different from the first position and the second position of the substrate,
any one of the first divided image, the second divided image, and the third divided image used in the N^{th} processing cycle is generated in the N−3^{rd} cycle,
another one of the first divided image, the second divided image, and the third divided image used in the N^{th} processing cycle is generated in the N−2^{nd} processing cycle, and
the remaining one of the first divided image, the second divided image, and the third divided image used in the N^{th} processing cycle is generated in the N−1^{st} cycle, and the N is a natural number greater than or equal to 4.

7. The printing method of claim 1, wherein each of the processing cycles includes:
a test operation of testing a head unit having a plurality of nozzles that discharges ink to check states of the nozzles;
a print image generation operation of, based on the states of the nozzles checked in the test operation, generating at least one of the divided images containing information about the nozzles to participate in printing; and
a print operation of performing printing on the substrate by using the print image.

8. The printing method of claim 7, wherein in each of the processing cycles, the print image generation operation and the print operation are performed after the test operation.

9. The printing method of claim 8, wherein in each of the processing cycles, the print image generation operation and the print operation are performed in parallel.

10. A control method of controlling a printing apparatus,
the printing apparatus including:
a printing stage;
a transfer unit for transferring a substrate on the printing stage; and
a head unit for discharging ink to the substrate transferred by the transfer unit,
the control method comprising: performing printing on the substrate by using a print image in which divided images generated at different times are combined.

11. The control method of claim 10, wherein some of the divided images are generated in a preparation cycle, which is a cycle before the printing is performed.

12. The control method of claim 11, wherein the preparation cycle includes a test operation of testing the head unit and a print image generation operation of generating an entirety of the print image.

13. The control method of claim 10, wherein each processing cycle of performing printing on a substrate is performed multiple times, and in each processing cycle, the print image is printed on the substrate,
a portion of the divided images used in the N^{th} processing cycle is generated in the N−2^{nd} processing cycle, and
the other portion of the divided images used in the N^{th} processing cycle is generated in the N−1^{st} processing cycle, where N is a natural number greater than or equal to 3.

14. The control method of claim 10, wherein each processing cycle of performing printing on a substrate is performed multiple times, and in each processing cycle, the print image is printed on the substrate,
in the processing cycle of an even-numbered cycle, a first divided image among the divided images is generated, and
in the processing cycle of an odd-numbered cycle, a second divided image among the divided images is generated.

15. The control method of claim 10, wherein a portion of the divided images is generated in the processing cycle in which the printing is performed.

16. The control method of claim 13, wherein each of the processing cycles includes:
a test operation of testing nozzles of the head unit to check states of the nozzles;
a print image generation operation of, based on the states of the nozzles checked in the test operation, generating at least one of the divided images containing information about the nozzles to participate in printing; and
a print operation of performing printing on the substrate by using the print image.

17-20. (canceled)
